(19) United States
(12) Patent Application Publication
(10) Pub. No.: US 2011/0274381 A1
(43) Pub. Date: Nov. 10, 2011

(54) BEARING ARRANGEMENT AND METHOD FOR ITS PRODUCTION

(76) Inventor: Wolfgang Ißler, Schwaikheim (DE)

(21) Appl. No.: 13/102,556

(22) Filed: May 6, 2011

(30) Foreign Application Priority Data
May 8, 2010 (DE) 102010019951.6

(51) Int. Cl. F16C 35/00; B21D 53/10

(52) U.S. Cl. 384/428; 29/898

(57) ABSTRACT

A bearing arrangement may comprise a component mounted in a housing and a bearing pin penetrating a bearing bore of the component. Holding bores may align with the housing and an outside surface of the bearing pin may connect and penetrate the holding bores of the housing with an adhesive bond. A method for the production of a bearing arrangement may include providing a component with a bearing bore, and mounting the component in a housing having first and second holding bores. The method may also include mounting a bearing pin by: guiding the bearing pin through the first holding bore, guiding the bearing pin through the bearing bore, and guiding the bearing pin through the second holding bore. Before the mounting of the bearing pin into the holding bore, the method may include applying an adhesive onto a free end of the bearing pin associated with the holding bore.

The present invention concerns a bearing arrangement, in which a component is mounted in a housing, with a bearing pin which penetrates a bearing bore of the component and holding bores of the housing in alignment therewith. The present invention further concerns a method for the production of a bearing arrangement, in which a component provided with a bearing bore is mounted in a housing, provided with holding bores, by means of the mounting of a bearing pin, wherein the bearing pin is firstly guided through the first holding bore, then through the bearing bore and finally through the second holding bore.

Such bearing arrangements are known and are used for example for the bearing of rocker levers or cam followers or rams as components of valve trains or of fuel pump drives for internal combustion engines. In such bearing arrangements, it is fundamental that the bearing pin can not move or even loosen in axial direction. For this purpose, in the prior art the bearing pin is caulked in the region of its free ends (see DE 196 12 969 A1, DE 43, 24 835 A1) or is widened in circumference by upsetting (see WO 2008/058836 A1). This has the disadvantage that the bearing pin must have regions of different material hardness, i.e. must have a lesser hardness in the region of its free ends, such that the caulking or upsetting is made possible.

The object of the present invention consists in providing a bearing arrangement, the mounting of which is simplified compared with the prior art and the axial securing in position of the bearing pin of which is improved. The object of the present invention further consists in providing a simple and favourably priced method for the production of such a bearing arrangement.

The solution consists in that the outside surface of the bearing pin is connected by an adhesive bond with the holding bores in its regions penetrating the holding bores of the housing. The method according to the invention is distinguished in that before the mounting of the bearing pin into the second holding bore, an adhesive is introduced and an adhesive is applied onto the free end of the bearing pin associated with the first holding bore.

Owing to the adhesive bond which is provided according to the invention, the bearing arrangement according to the invention makes possible an improved force fit between the bearing pin and the housing, and hence a more reliable axial securing of the bearing pin. Thereby, it is no longer necessary to produce bearing pins with regions of differing material hardness. The production of the bearing arrangement according to the invention is therefore simplified and hence favourably priced.

The method according to the invention constitutes a particularly economical possibility for the mounting of the bearing arrangement according to the invention. It can be implemented by the simplest means and is accordingly to be carried out economically. In so doing, in particular it is avoided that adhesive penetrates into the bearing region of the component, in particular into the bearing bore. The bearing of the component is therefore not impaired.

Advantageous further developments will be apparent from the subclaims.

Preferably, a cold-hardening adhesive is used, as is also used for example for the bonding of cams with cam shafts, e.g. Loctite 640 of Henkel A G Germany.

A further preferred embodiment of the present invention consists in that the bearing pin has a roughened surface in its regions penetrating the holding bores of the housing. Thereby, an additional force fit is achieved, which further improves the adhesive bond and hence the axial securing in position of the bearing pin. The roughened surfaces can be produced for example by milling, stamping or blasting.

Example embodiments of the present invention are explained in further detail below with the aid of the enclosed drawings. In a diagrammatic representation, not to scale, there are shown:

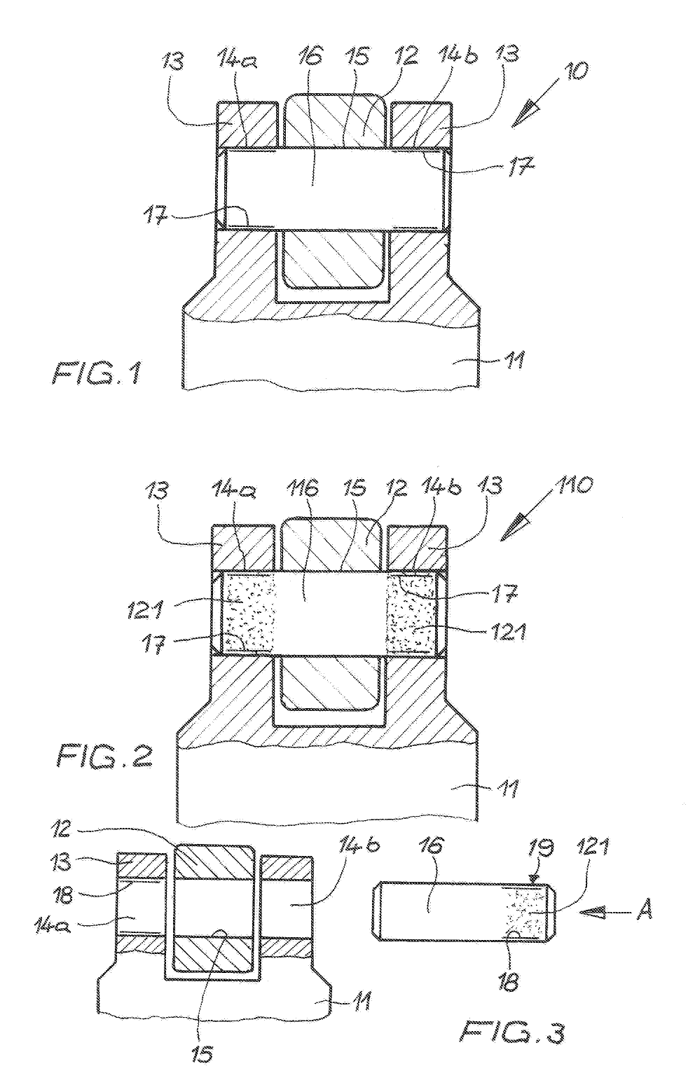

FIG. 1 a first example embodiment of a bearing arrangement according to the invention, in section;

FIG. 2 a further example embodiment of a bearing arrangement according to the invention, in section;

FIG. 3 an example embodiment of an arrangement for the method according to the invention.

FIG. 1 shows a first example embodiment of a bearing arrangement 10 according to the invention. The bearing arrangement 10 has a housing 11 with bearing blocks 13 and a component 12 mounted in the housing 11 between the bearing blocks 13. The component 12 can, for example, be a movable roller for the movement of the ram in a fuel pump of an internal combustion engine by contact with a cam, which is not illustrated, or for controlling a valve of an internal combustion engine. The illustration of a bearing mechanism for the component 12 was omitted, for reasons of clarity.

The bearing blocks 13 of the housing 11 have holding bores 14a, 14b, whilst the component 12 has a continuous bearing bore 15, in alignment with the holding bores 14a, 14b. A bearing pin 16 penetrates the holding bores 14a, 14b and the bearing bore 15.

Adhesive bonds 17 are provided between the bearing pin 16 and the holding bores 14a, 14b for the axial securing of the bearing pin 16 in the bearing blocks 13 of the housing 11. A Loctite 640 was used to produce the adhesive bonds 17 in the example embodiment. The bearing pin 16 therefore consists of a material with a uniform material hardness. No additional processing of the bearing pin 16 is necessary to reduce the material hardness in the region of the holding bores 14a, 14b.

FIG. 2 shows a further example embodiment of a bearing arrangement 110 according to the invention. The bearing arrangement 110 has substantially the same structure as the bearing arrangement 10 according to FIG. 1. Identical components are therefore provided with the same reference numbers, and in this respect reference is to be made to the description of FIG. 1.

The bearing arrangement 110 has as an additional feature, compared with the bearing arrangement 10 according to FIG. 1, a bearing pin 116 which has a roughened surface 121 in its regions penetrating the holding bores 14a, 14b of the bearing blocks 13 of the housing 11. Thereby, an additional force fit is produced between the roughened surfaces 121 and the inner surfaces of the holding bores 14a, 14b and hence a reinforcing of the adhesive bonds 17. Thereby, the axial securing of the bearing pin 116 is further improved.

FIG. 3 shows an example embodiment of an arrangement for the method according to the invention for the production of the bearing arrangements illustrated in FIGS. 1 and 2. Here, the housing 11, the component 12 and the bearing pin 16 are oriented with respect to each other in a mounting direction along the arrow A. Before the mounting of the bearing pin 16, the adhesive 18, which is used to produce the adhesive bond, is introduced into the holding bore 14a. Likewise, the adhesive 18 is applied onto the free end 19 of the bearing pin 16 associated with the holding bore 14b in the finished mounted bearing arrangement. For mounting the bearing arrangement, the bearing pin 16 is firstly guided through the holding bore 14b of the housing 11, then through the bearing bore 15 of the component and finally through the holding bore 14a of the housing 11. Thereby, it is avoided that adhesive residues are carried into the bearing bore 15 and impair the bearing of the component 12.

The same, of course, also applies to the production of the bearing arrangement 116, wherein before the application of the adhesive 18 the surface of the bearing pin 116 is roughened as described for FIG. 2.

1. A bearing arrangement comprising: a component mounted in a housing, a bearing pin penetrating a bearing bore of the component, holding bores aligned with the housing, an outside surface of the bearing pin connecting and penetrating the holding bores of the housing with an adhesive bond.

2. The bearing arrangement according to claim 1, wherein the adhesive bond includes a cold-hardening.

3. The bearing arrangement according to claim 1, wherein regions of the outside surface of the bearing have a roughened surface for penetrating the holding bores of the housing.

4. The bearing arrangement according to claim 3, wherein the roughened surfaces are produced from at least one of stamping, milling and blasting.

5. A method for the production of a bearing arrangement comprising: providing a component with a bearing bore, mounting the component in a housing having first and second holding bores, mounting a bearing pin by: guiding the bearing pin through the holding bore, guiding the bearing pin through the bearing bore, and guiding the bearing pin through the first holding bore, and before the mounting of the bearing pin into the second holding bore, applying an adhesive onto a free end of the bearing pin associated with the holding bore.

6. The method according to claim 5, wherein the adhesive is a cold-hardening adhesive.

7. The method according to claim 5, further comprising, before the application of the adhesive, roughening regions of an outside service of the bearing pin associated with the holding bores.

8. The method according to claim 7, wherein the outside surface is roughened by at least one of stamping, milling and blasting.

9. The method according to claim 7, wherein the outside surface is roughened by stamping.

10. The method according to claim 7, wherein the outside surface is roughened by milling.

11. The method according to claim 7, wherein the outside surface is roughened by blasting.

12. The bearing arrangement according to claim 3, wherein the roughened surfaces are produced from stamping.

13. The bearing arrangement according to claim 3, wherein the roughened surfaces are produced from milling.

14. The bearing arrangement according to claim 3, wherein the roughened surfaces are produced from blasting.
